(19) United States
(12) Patent Application Publication
(10) Pub. No.: US 2003/0150268 A1
(43) Pub. Date: Aug. 14, 2003

(54) System and method for reducing electric discharge breakdown in electrostatically levitated MEMS devices

(75) Inventors: Nobuo Takeda, Richardson, TX (US); Risaku Toda, Plano, TX (US)

Correspondence Address: HAYNES AND BOONE, LLP, 901 MAIN STREET, SUITE 3100, DALLAS, TX, 75202, US

(73) Assignee: Ball Semiconductor, Inc., Allen, TX (US)

(21) Appl. No.: 10/071,149

(22) Filed: Feb. 8, 2002

(51) Int. Cl. G01P 15/00

(52) U.S. Cl. 73/514.18

(57) ABSTRACT

A system and method for reducing electric discharge breakdown occurrences in a micro-electromechanical system device is provided. The device comprises a core, a shell, and electrodes, which may be formed on the shell. When voltage is applied to the electrodes, each electrode applies an electrostatic force on the core. The electrodes are arranged in concentric sets, where each set may comprises two or more electrodes. Due to the concentricity of the electrodes, a minimum distance is maintained between the core and an outer electrode of an electrode set when the core nears or touches an inner electrode of the electrode set.

### BACKGROUND

The present disclosure relates generally to micro-electromechanical system (MEMS) devices, and more particularly, to the reduction of electric discharge breakdown occurrences in such devices.

Integrated circuit devices, such as MEMS, may have one or more small gaps placed within the circuit to allow the device to respond to mechanical stimuli. One common MEMS device is a sensor, such as an accelerometer, for detecting external force, acceleration or the like by electrostatically or magnetically floating a portion of the device. The floating portion can then move responsive to the acceleration and the device can detect the movement accordingly. In some cases, the device has a micro spherical body referred to as a core, and a surrounding portion referred to as a shell. Electrodes in the shell serve not only to levitate the core by generating an electric or magnetic field, but to detect movement of the core within the shell by measuring changes in capacitance and/or direct contact of the core to the shell.

The application of an electrostatic force may be accomplished by applying a voltage to the electrodes. In some designs, two or more electrodes may be in relatively close proximity, with each electrode exerting an electrostatic force on the core. If each electrode is exerting an identical force and the core is at an equal distance from each electrode, then the core is equally attracted to each electrode. Assuming that a system of electrodes comprises a sphere of opposing electrodes (e.g., for each electrode attracting the core there is an electrode exerting an equal and opposite attraction on the core), then the core will be held in place by the electrostatic forces.

However, if an external force directs the core toward a particular electrode, then that electrode may exert an increasingly strong attractive force on the core relative to the other electrodes. A control circuit may be designed to alter the voltages to the various electrodes to correct such an occurrence, but may not be able to respond quickly enough to prevent the core from touching the electrode exerting the stronger attraction. The core may also touch or approach a neighboring electrode. This may provide an electrical connection between the two electrodes and result in an electric discharge breakdown, which may destroy or severely damage the object and the surrounding MEMS. Such a system may be unstable and so undesirable for certain applications.

Accordingly, certain improvements are desired for electrostatic MEMS systems. For one, it is desirable to provide an electrode arrangement that reduces the occurrence of electric discharge breakdown. In addition, it is desired to provide the electrodes on a spherical MEMS. It is also desirable to provide high productivity and to be more flexible and reliable.

### SUMMARY

A technical advance is provided by a novel system and method for a micro-electromechanical system device. In one embodiment, the device includes a core, a shell surrounding at least a portion of the core, and a first electrode and a second electrode positioned proximate to the shell and operable to exert an electrostatic force on the core. The first and second electrodes are arranged concentrically with respect to one another, so that the occurrence of electric discharge breakdowns is reduced.

In another embodiment, the electrodes are circular. In still another embodiment, the core and the shell are spherical. In yet another embodiment, the core and the shell are sized relative to each other so that, if the core touches the first electrode, a minimum distance will be maintained between the second electrode and the core. The minimum distance aids in the reduction of electric discharge breakdowns.

### BRIEF DESCRIPTION OF THE DRAWINGS

FIG. 1 illustrates a portion of an electrostatic actuation device for implementing various embodiments of the present invention.

FIG. 2 illustrates the positioning of an adjacent, semicircular electrode pair on a spherical micro-electromechanical system device.

FIG. 3 is a side view of the device of FIG. 2 illustrating the positioning of an electrode pair and a stabilized core.

FIG. 4 is a side view of the device of FIG. 2 illustrating the positioning of an electrode pair and a displaced core.

FIG. 5 illustrates the positioning of a concentric electrode pair on a spherical micro-electromechanical system device.

FIG. 6 is a side view of the device of FIG. 5 illustrating the positioning of an electrode pair and a stabilized core.

FIG. 7 is a side view of the device of FIG. 5 illustrating the positioning of an electrode pair and a displaced core.

### DETAILED DESCRIPTION

The present disclosure relates generally to micro-electromechanical system devices, and more particularly, to the reduction of electric discharge breakdown occurrences in such devices. It is understood, however, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Referring to FIG. 1, a spherical micro-electromechanical system (MEMS) device 100 is one example of a device that can benefit from the present invention. The MEMS device 100 may be created using a process similar to that described in U.S. Pat. No. 6,197,610, issued on Mar. 6, 2001, and also assigned to Ball Semiconductor, Inc., entitled “METHOD OF MAKING SMALL GAPS FOR SMALL ELECTRICAL/MECHANICAL DEVICES” and hereby incorporated by reference as if reproduced in its entirety. In the present example, the MEMS may utilize opposing sets of electrodes 104, 106 and 108, 110 (e.g., capacitive plates) positioned proximate to a shell (not shown) to exert an electrostatic force on a spherical core 102 to provide an electrostatic actuator. In the present example, only the electrodes for a single axis are shown for purposes of clarity.

Electrostatic levitation may be implemented by applying direct current (DC) voltage to the electrodes 104-110. Generally speaking, the electrostatic force applied to two parallel plates is

$$F = \frac{ϵ {SV}^{2}}{2 {d}^{2}} \qquad ( 1 )$$

where ε=dielectric constant, S=plate area, V=voltage, and d=gap width between plates. The electrostatic force is an attractive force regardless of the voltage polarity.

In operation, a first pair of DC voltages of opposite polarity (e.g., +V1 and −V1) are applied to the pair of electrodes 104, 106 above the core 102. A second pair of DC voltages of opposite polarity are applied to the pair of electrodes 108, 110 below the core 102. The application of voltages of opposite polarity serves to maintain the core 102 at an electrically neutral potential. The attractions exerted on the core 102 by the two pairs of electrodes 104, 106 and 108, 110 maintain the position of the core 102 at a location between the electrodes 104-110. It is noted that the gap between the core 102 and the electrodes 104-110 may be relatively small.

The voltages applied to the electrodes 104-110 may be controlled by a control circuit. For example, the control circuit may use closed-loop means to stabilize the position of the core 102. The position of the core 102 may be measured capacitively using the electrodes 104-110, and then fed back to the electrodes 104-110 to adjust for displacements that may occur. Accordingly, if an outside force alters the position of the core 102 relative to the electrodes 104-110, the closed-loop means may recenter the core 102.

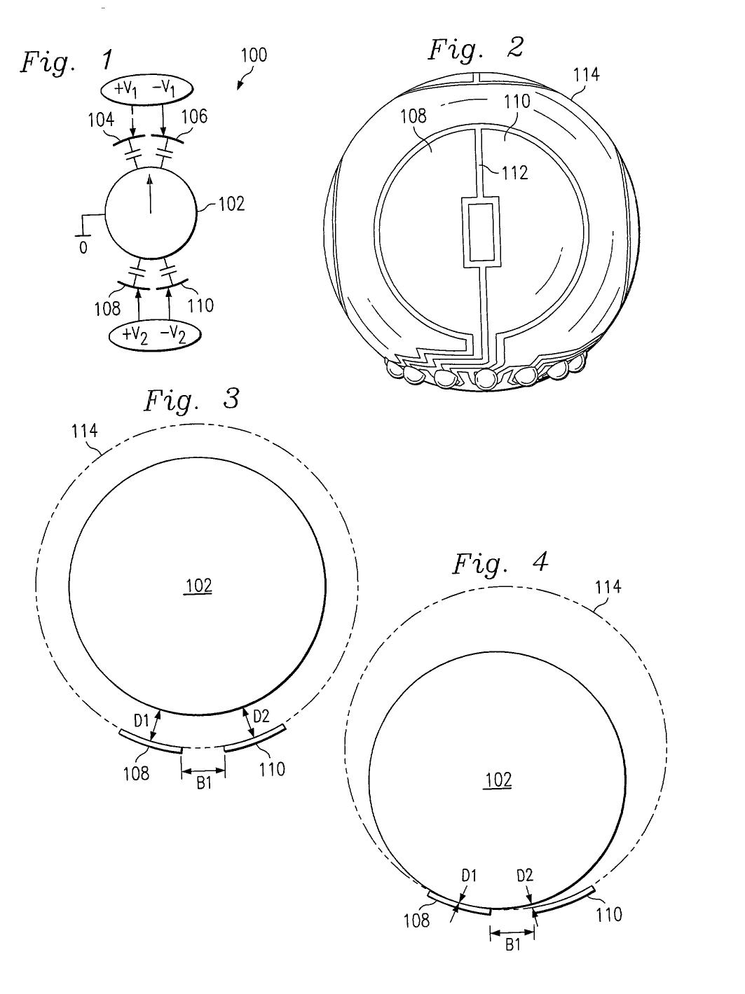

Referring now to FIG. 2, in another embodiment, each electrode of the electrode pairs 104, 106 and 108, 110 of FIG. 1 may be shaped as a semicircle. In the present example, each of the electrodes 104, 110 may be shaped as a half circle, and so may form an approximate circle when paired together. A boundary line 112 exists between the electrodes 104, 106 and 108, 110 of each pair where the two electrodes forming each pair lie next to each other. The boundary line 112 may be a region of the MEMS 100 where electric discharge breakdown may occur for reasons described in reference to FIGS. 3 and 4.

Referring now to FIG. 3, the core 102 of FIG. 1 is shown proximate to the semicircular electrodes 108, 110 of FIGS. 1 and 2. For purposes of example, an outer sphere 114 illustrates the position of the core 102 relative to its neutral position (e.g., the neutral position of the core 102 may be the center of the outer sphere 114). The outer sphere 114 may be a shell surrounding the core 102. It is noted that the actual position of the electrodes 108, 110 may vary relative to the shell 114, and so may be outside or inside the shell 114, or may be embedded in the shell 114. The boundary line 112 between the electrodes may represent a distance B1.

When the core 102 is neutrally positioned (e.g., no force is acting on the core 102 other than the equal electrostatic attractions of the electrodes 104-110, and possibly gravity), a gap distance D1 may separate the electrode 108 from the core 102 and a gap distance D2 may separate the electrode 110 from the core 102. When the core 102 is in the neutral position, the gap distances D1 and D2 may be equal. In addition, the gap distances D1 and D2 may be the same along each point of their respective electrodes 108, 110 when the core 102 is in its neutral position.

As described previously, a control circuit may be utilized to maintain the position of the core 102 relative to the surrounding electrodes 104-110. However, maintaining the position of the core 102 relative to the surrounding electrodes 104-110 may be difficult in some situations due to the attractive forces exerted by each electrode 104-110.

Referring now to FIG. 4, for example, if an external force were to direct the core 102 towards the electrode 108 (reducing the gap distance D1), then the electrode 108 would exert an increasingly strong attractive force on the core 102 relative to the other electrodes 104, 106, and 110. If the control circuit fails to correct the position of the core 102 relative to the electrodes 104, 106, and 110 quickly enough, the core 102 may near or actually contact the electrode 108 and reduce the gap distance D1 to an infinitely small value.

Due in part to the close proximity of the two electrodes 108, 110, the core 102 may also approach the electrode 110 (e.g., the gap distance D2 may also be reduced). When this occurs, the gap distance D2 may be smallest at the point of the electrode 110 that is nearest to the boundary line 112. Accordingly, the core 102 may be close enough to the two electrodes 108, 110 to provide a current path between the two electrodes 108, 110 while the DC voltages are being applied to the electrodes 108, 110. This may result in an electric discharge breakdown, which may destroy or severely damage the core 102 and the surrounding MEMS.

In general, the breakdown characteristics of a gap are a function (generally not linear) of the product of the gas pressure and the gap distance, which may be written as

V=f(pd) (2)

where p=pressure and d=gap distance between an electrode and the core 102. In actuality, the pressure may be replaced by the gas density. Accordingly, a larger gap between an electrode and the core 102 may reduce the occurrence of electric discharge breakdown.

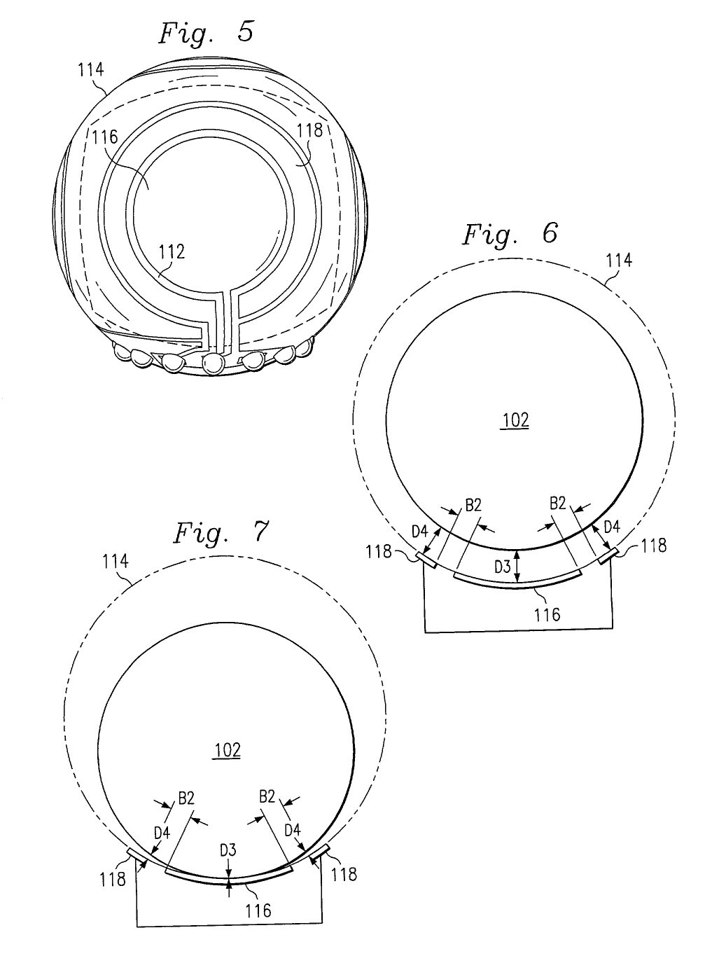

Referring now to FIG. 5, in yet another embodiment, a pair of electrodes 116, 118 are arranged as concentric circles rather than as the adjacent semicircles as described previously in relation to the electrode pairs 104, 106 and 108, 110. The concentricity of the electrode pair 116, 118 may be operable to reduce the occurrence of electric discharge breakdown by providing a greater gap distance between an electrode and the core 102 as is described in reference to FIGS. 6 and 7.

Referring now to FIG. 6, a single concentric electrode pair 116, 118 is illustrated proximate to the core 102 of FIG. 1. In contrast to the semicircular electrode pairs 104, 106 and 108, 110 described previously, the concentric arrangement of the electrodes 116, 118 provides a relatively wider gap between the outside electrode 118 and the core 102 when the core 102 nears the electrodes 116, 118 as will be described below. When the core 102 is neutrally positioned (e.g., no force is acting on the core 102 other than the equal electrostatic attractions of the electrodes 104-110, and possibly gravity), a gap distance D3 may separate the electrode 116 from the core 102 and a gap distance D4 may separate the electrode 118 from the core 102.

For purposes of example, the shell 114 described previously illustrates the position of the core 102 relative to its neutral position (e.g., the neutral position of the core 102 may be the center of the shell 114). The boundary line 112 between the electrodes 116, 118 may represent a distance B2.

Referring now to FIG. 7, because the electrodes 116, 118 are concentric circles, they have the same center point. Therefore, if the core 102 is directed by an external force towards the electrodes 116, 118, the core 102 will be attracted towards the center point. If the control circuit fails to correct the position of the core 102 quickly enough, the core 102 may near or actually contact the electrode 116. This has the effect of reducing the gap distance D3 to an infinitely small value. Due in part to the close proximity of the two electrodes 116, 118, the core 102 may also approach the electrode 118 (e.g., the gap distance D4 may also be reduced). However, due to the concentric layout of the electrodes 116, 118, the gap distance D4 may remain relatively large compared to the gap distance D2 of the semicircular electrode arrangement of FIG. 4 (e.g., D3≈D1, but D4>D2), reducing the possibility of an electric discharge breakdown. This reduction may occur even when the distances B1 and B2 between the electrodes are equal.

While the invention has been particularly shown and described with reference to the preferred embodiment thereof, it will be understood by those skilled in the art that various changes in form and detail may be made therein without departing from the spirit and scope of the invention. For example, it is within the scope of the present invention to use multiple concentric electrodes. In addition, gap distances may be varied between the electrodes and the core. Also, distances between electrodes along the boundary line may be varied. Therefore, the claims should be interpreted in a broad manner, consistent with the present invention.

What is claimed is:

1. A micro-electromechanical system device, the device comprising:
a core;
a shell surrounding at least a portion of the core; and
a first electrode and a second electrode positioned proximate to the shell and operable to exert an electrostatic force on the core, the first and second electrodes being arranged concentrically with respect to one another, so that the occurrence of electric discharge breakdowns is reduced.

2. The device of claim 1 wherein the electrodes are circular.

3. The device of claim 1 wherein the core and the shell are spherical.

4. The device of claim 1 wherein the device is an accelerometer.

5. The device of claim 1 wherein the core comprises a dielectric material.

6. The device of claim 1 wherein the core and the shell are sized relative to each other so that, if the core touches the first electrode, a minimum distance will be maintained between the second electrode and the core, the minimum distance aiding in the reduction of electric discharge breakdowns.

7. The device of claim 1 further including a control means, the control means operable to sense changes in a position of the core relative to the shell and to alter a voltage in at least one of the first and second electrodes to maintain the position of the core relative to the shell.

8. A micro-electromechanical system, the system comprising:
a spherical core;
a spherical shell surrounding the core; and
a first electrode and a second electrode positioned proximate to the interior of the shell, the first and second electrodes being concentrically arranged, so that electric discharge breakdown occurrences are minimized when an electrostatic force is exerted on the core.

9. The system of claim 8 wherein the first and second electrodes are circular.

10. The system of claim 8 wherein the first and second electrodes exert a capacitive force on the core.

11. The system of claim 8 wherein the first and second electrodes are charged using voltages of opposite polarity.

12. The system of claim 8 further including a third electrode and a fourth electrode, the third and fourth electrodes being positioned proximate to the shell at a location opposite to that of the first and second electrodes.

13. The system of claim 12 further including a control means, the control means operable to sense changes in a position of the core relative to the shell and to alter a voltage supplied to at least one of the first, second, third, or fourth electrodes to maintain the position of the core relative to the shell.

14. The system of claim 8 wherein the core is dielectric.

15. The system of claim 8 wherein the core and the shell are sized relative to each other so that, if the core touches the first electrode, a minimum distance will be maintained between the second electrode and the core, the minimum distance aiding in the reduction of electric discharge breakdowns.

16. A method for reducing the occurrence of electric discharge breakdowns in a micro-electromechanical system comprising a core and a shell, the method comprising:
creating at least a first electrical path and a second electrical path on the shell; and
creating a first electrode and a second electrode on the shell, the first and second electrodes sharing a common center point and accessible to the first and second electrical paths, respectively;
so that power can be provided to the first and second electrodes, the power enabling the first and second electrodes to exert an electrostatic force on the core.

17. The method of claim 16 further including providing a third electrode and a fourth electrode, the third and fourth electrodes concentrically arranged and operable to offset the electrostatic force exerted by the first and second electrodes.

18. The method of claim 17 further including sensing a change in a position of the core relative to the shell and altering the voltage in at least one of the first, second, third, or fourth electrodes to maintain the position of the core relative to the shell in response to the sensed change.
